(19) United States
(12) Patent Application Publication
(10) Pub. No.: US 2015/0229001 A1
(43) Pub. Date: Aug. 13, 2015

(54) MOLTEN SALT COMPOSITION AND SECONDARY BATTERY USING THE MOLTEN SALT COMPOSITION

(71) Applicants: Sumitomo Electric Industries, Ltd., Osaka-shi, Osaka (JP); KYOTO UNIVERSITY, Kyoto-shi, Kyoto (JP)

(72) Inventors: Eiko Itani, Osaka-shi (JP); Shinji Inazawa, Osaka-shi (JP); Koji Nitta, Osaka-shi (JP); Shouichirou Sakai, Osaka-shi (JP); Atsushi Fukunaga, Osaka-shi (JP); Koma Numata, Osaka-shi (JP); Rika Hagiwara, Kyoto-shi (JP); Toshiyuki Nohira, Kyoto-shi (JP); Kazuhiko Matsumoto, Kyoto-shi (JP)

(21) Appl. No.: 14/422,189

(22) PCT Filed: Aug. 12, 2013
(86) PCT No.: PCT/JP2013/071770

§ 371 Date: Feb. 18, 2015

(30) Foreign Application Priority Data
Aug. 21, 2012 (JP) 2012-182482

(51) Int. Cl. H01M 10/056

(52) U.S. Cl. CPC H01M 10/056; H01M 2300/0091; H01M 2300/0022; H01M 2300/0045

(57) ABSTRACT

As a molten salt composition lacking a clear melting point and including a molten salt that can be suitably used as an electrolytic solution of a secondary battery, there is provided a molten salt composition including a mixture of two or more kinds of molten salts which can be used as an electrolytic solution of a secondary battery. Particularly, provided is a molten salt composition comprising two kinds of molten salts each having cations with ion diameters different from each other, composition ratio being set to a composition ratio within a range in which the molten salt composition lacks a melting point. Also provided is a secondary battery including the molten salt composition as an electrolytic solution, which can maintains an available state even when the temperature becomes low without rapidly becoming unavailable.

### TECHNICAL FIELD

The present invention relates to a molten salt composition which becomes an electrolytic solution in a melted state, and a secondary battery including the molten salt composition as an electrolytic solution.

### BACKGROUND ART

A secondary battery (storage battery) capable of storing and charging/discharging electrical energy is widely utilized for storage of power, leveling of the supply of power, and the like. As a secondary battery, a lithium ion secondary battery is known as a battery having high energy density. However, the lithium ion secondary battery has a problem of safety, since a flammable organic compound liquid is used therein as an electrolytic solution. In addition, lithium which is used as a material has a problem on securing of resource, since the resource is unevenly distributed and its remaining amount is of a concern.

In recent years, as a secondary battery having an advantage of being nonflammable in addition to high energy density, a molten salt battery including a molten salt as an electrolytic solution has been developed and is attracting attention. The temperature range in which the molten salt battery can operate is wider compared to that of other secondary batteries such as a lithium battery. Thus, expected use application of the molten salt battery includes use application for storage of power in a mid-size power network, homes, and the like, and on-board use application in a truck and a bus, and the like.

As a molten salt which can be used at a relatively low temperature, Patent Literature 1 discloses a molten salt composition (and a use thereof) containing two or more kinds of molten salts of which anion is (FSO₂)₂N⁻ ((fluorosulfonyl)amide: hereinafter referred to as FSA) and of which cation is an alkali metal selected from the group consisting of Li, Na, K, Rb, and Cs. Since the molten salt composition can be used in a temperature range of not lower than 60° C. but not higher than 130° C., the molten salt composition is expected to be used in a fuel cell, a secondary battery, capacitor, and the like.

In Patent Literature 2, as a secondary battery which can operate at a low temperature of not higher than 100° C., there is proposed a battery (sodium secondary battery) including a positive electrode, a negative electrode of which main component is Na, and an electrolytic solution provided between the positive electrode and the negative electrode, wherein the electrolytic solution is a molten salt of which anion is an anion represented by (RSO₂)₂N⁻ (two “R”s each independently represent a fluorine atom or a fluoroalkyl group) and of which cation is a metal selected from an alkali metal and an alkaline earth metal. In addition, as a preferable electrolytic solution, a mixture of sodium bis(fluorosulfonyl)amide (NaFSA) and potassium bis(fluorosulfonyl)amide (KFSA) is also disclosed.

Although a molten salt melts to become an electrolytic solution at a temperature equal to or higher than a melting point thereof, the molten salt is highly viscous and has low ionic conductivity around the melting point. Thus, it is preferred that the molten salt is used at a temperature about +30° C. above the melting point of the electrolytic solution, or higher. Therefore, in order to obtain a molten salt battery which can be used at room temperature without being warmed, a molten salt of which melting point is below freezing point is preferably used as the electrolytic solution. However, the melting point (eutectic point) of a molten salt obtained by mixing two kinds of salts of KFSA and NaFSA is 61° C.

In order to set the melting point of a molten salt below freezing point, a method of lowering the melting point by mixing an ionic liquid with a molten salt is known. For example, when mixing methyl propylpyrrolidinium FSA salt (the melting point by itself is −12° C.) to NaFSA in proportions of 1:9 (mole ratio), the melting point is reduced to −25° C. Thus, by using this molten salt composition as an electrolytic solution a molten salt battery which is preferable for use at room temperature can be obtained.

### CITATION LIST

### Patent Literature

Patent Literature 1: Japanese Laid-Open Patent Publication No. 2009-67644

Patent Literature 2: WO2011/036907

### SUMMARY OF INVENTION

### Technical Problem

When a molten salt solidifies at temperature below its melting point, the ionic conductivity rapidly decreases. Thus, in a secondary battery including as an electrolytic solution a molten salt having a clear melting point, the performance as a battery rapidly changes below the melting point. For a battery used in an environment with temperature changes, it is a problem that the battery rapidly becomes unavailable due to change in temperature. Thus, there is a demand for a molten salt battery which can maintain an available state even when the temperature becomes low without rapidly becoming unavailable.

An object of the present invention is to provide a molten salt composition which can be used as an electrolytic solution of a secondary battery, and which can provide a secondary battery that maintains an available state even when the temperature becomes low without rapidly becoming unavailable. Another object of the present invention is to provide a secondary battery which can maintain an available state even when the temperature becomes low without rapidly becoming unavailable, the battery including the molten salt composition as an electrolytic solution.

### Solution to Problem

As a result of intensive study, the present inventor found that it is possible to obtain a molten salt composition lacking a clear melting point by mixing two or more kinds of molten salts, and a secondary battery (molten salt battery), which does not rapidly become unavailable even when the temperature becomes low, can be produced by using the molten salt composition lacking a clear melting point as an electrolytic solution, whereby the present invention has been achieved.

One embodiment of the invention is a molten salt composition (composite molten salt) including a mixture of two or more kinds of molten salts that can be used as an electrolytic solution of a secondary battery, and lacking a clear melting point.

The molten salt composition is characterized in that the molten salt composition lacks a clear melting point. Although viscosity of the molten salt composition lacking a clear melting point increases, the molten salt composition does not rapidly solidify when a temperature is lowered. In addition, when the molten salt composition lacking a clear melting point is used as an electrolytic solution, the function thereof is not rapidly lost. The meanings of “a molten salt composition lacks a clear melting point” is that a clear endothermic peak is not observed in the DSC curve on elevating temperature when differential scanning calorimetry (DSC measurement) is performed on the molten salt composition. The molten salt composition of the embodiment lacks a clear melting point but can have other transition points such as a glass transition point.

When a molten salt forming an electrolytic solution has a clear melting point, when the temperature is lowered near the melting point, fluidity of the electrolytic solution becomes low rapidly and a battery rapidly becomes unavailable. However, since the molten salt composition of the present invention lacks a clear melting point, a molten salt battery (secondary battery) including the molten salt composition as an electrolytic solution is maintained in an available state without rapidly becoming unavailable even when the temperature is lowered.

The molten salt composition lacking a clear melting point can be obtained by mixing two or more different kinds of molten salts. As described in the following, even if the two or more kinds of the molten salt forming the molten salt composition each have a clear melting point, there is a case in which the clear melting points is disappeared by mixing the two or more kinds of the molten salt.

Solidification is a phenomenon in which ions arranged disorderly in a melt state settle in an orderly arrangement below a melting point. A macro molecule chain such as an organic polymer is unlikely to take a well-ordered arrangement because of collapsed symmetry due to bending, rotation, and the like occurring somewhere in a molecule chain. Therefore, there is a case where a wide transition point at which a clear melting point does not appear and solidification occurs gradually.

As a result of study, the present inventor found that a molten salt composition lacking a clear melting point can be obtained also when two or more different kinds of molten salt are mixed, whereby the present invention is accomplished by the finding obtained. Specifically, the present inventor found that a molten salt composition not having a melting point but only having a glass transition point is obtained, when a FSA salt and a salt of which molecule is larger than the FSA salt and which is in a liquid state at an ordinary temperature are combined. The present inventor also found that, among compositions obtained by combining two kinds of molten salts having different cations at a specific range of composition ratio, there exists a composition that does not exhibit a clear melting point and solidifies gradually when being cooled. Regarding an ordinary molten salt, the molten salt is rearranged in a well-ordered manner and crystallizes and solidifies at a single temperature, when the temperature of the molten salt is lowered from a temperature at which the molten salt is liquid. Therefore, the ordinary molten salt has a melting point. However, it is difficult that a single well-ordered crystal structure is formed by a molten salt composition including two or more different kinds of molten salts such as in the case of a molten salt composition having coexisting therein ions of which ion radii are significantly different. Therefore, a phenomenon may be sometimes observed in which solidification does not occur at a single temperature and a clear melting point is not exhibited.

Another embodiment of the invention is the molten salt composition, wherein at least one kind of the molten salts among the two or more kinds of the molten salts is a molten salt (hereinafter, referred to as “molten salt 2”) having a melting point not higher than 25° C.

The molten salt 2 is a salt which is in a liquid state at an ordinary temperature (specifically, 25° C.). Among molten salts, a salt of which melting point is not higher than 100° C. is often referred to as an ionic liquid. The molten salt 2 can also be referred to as an ionic liquid, since the molten salt 2 is in a liquid state at 25° C. By using the molten salt 2 which is liquid at 25° C. as a molten salt forming the molten salt composition of the present invention, a molten salt composition that is liquid with large fluidity even at an ordinary temperature is obtained. Thus, by using the molten salt composition as an electrolytic solution, a secondary battery suitable for operation at an ordinary temperature can be obtained.

Another embodiment of the invention is the molten salt composition, wherein at least one kind of the molten salts among the two or more kinds of the molten salts is a molten salt (hereinafter, referred to as “molten salt 1”) including an alkaline metal cation and an anion represented by

(RSO₂)₂N⁻

wherein two “R”s each independently represent a fluorine atom or a fluoroalkyl group.

Examples of a molten salt which can form a molten salt composition lacking a clear melting point when being mixed with the molten salt 2 include the molten salt 1 including an alkaline metal cation and an anion represented by (RSO₂)₂N⁻.

Another embodiment of the invention is the molten salt composition, wherein an anion forming the molten salt 2 is an anion represented by (RSO₂)₂N⁻ wherein two “R”s each independently represent a fluorine atom or a fluoroalkyl group; wherein an ion diameter of a cation forming the molten salt 2 is not smaller than 3 times of an ion diameter of the alkaline metal cation forming the molten salt 1; and wherein a composition ratio of the molten salt 1 and the molten salt 2 is a composition ratio within a range in which the molten salt composition lacks a clear melting point.

Since the alkaline metal cation (Naion, and the like.) is an ion consisting of a single atom and can be considered a sphere, the ion diameter is defined as a length (diameter) twice the ion radius described by Pauling. On the other hand, for the ion of molecules such as the cation forming the molten salt 2, the ion diameter is defined as the longest side in a molecule model obtained using the molecular orbital method and performing an energy minimization calculation of the molecule through Hartree-Fock method with an STO-3G predetermined function set.

The molten salt composition is a composition containing two kinds of molten salts (the molten salt 1 and the molten salt 2) formed from two kinds of cations having different ion diameters. The anions of the two kinds of molten salts are both an anion represented by (RSO₂)₂N⁻ wherein two “R”s each independently represent a fluorine atom or a fluoroalkyl group. The “R” in the anion (RSO₂)₂N⁻ forming the molten salt 1 and the “R” in the anion (RSO₂)₂N⁻ forming the molten salt 2 can be identical or different.

Examples of the alkaline metal cation forming the molten salt 1 include an ion such as Na⁺ ion having ion diameters of 1.9 angstrom and K⁺ ion having ion diameters of 2.7 angstrom. The cation forming the molten salt 2 has the ion diameter of not smaller than 3 times, preferably 3.5 to 9 times, and more preferably 4 to 6 times of that of the cation forming the molten salt 1.

In a case where the composition ratio of molten salt 1:molten salt 2 is 1:9 and the cation forming the molten salt 1 is Na⁺ ion, the viscosity of the molten salt composition when the cation forming the molten salt 2 is 1-methyl-1-butyl piperidinium ion (Pip14 ion, melting point: 5° C., ion diameter: 11.29 angstrom) represented by the following formula (1) becomes approximately 3 times or larger when compared to the viscosity of the molten salt composition when the cation is 1-methyl-1-propylpyrrolidinium ion (MPPyr ion, ion diameter: approximately 9.4 angstrom) represented by the following formula (2). The ratio between ion diameters of Pip14 ion and Na⁺ ion is 5.9 (=11.29/1.9), and the ratio between ion diameters of MPPyr ion and Na⁺ ion is approximately 4.9 (=approximately 9.4/1.9). When the ratio of ion diameters of the alkaline metal cation forming the molten salt 1 and the cation forming the molten salt 2 becomes large as above described, viscosity of the molten salt composition increases, and fluidity when being used as an electrolytic solution reduces. Thus, the ratio of ion diameters is preferably not larger than 9 times, and more preferably not larger than 6 times.

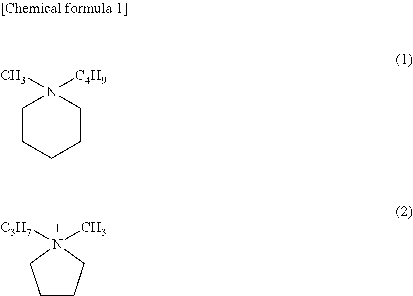

In the embodiment of the invention, the composition ratio between the molten salt 1 including a cation having a small ion diameter and the molten salt 2 including the cation having a large ion diameter is a composition ratio within a range in which the molten salt composition lacks a clear melting point. The range of the composition ratio varies depending on the kind of anion represented by (RSO₂)₂N⁻, the kind of the respective cations forming the molten salt 1 and the molten salt 2, and the ratio of ion diameters of the cation forming the molten salt 1 and the cation forming the molten salt 2.

Another embodiment of the invention is the molten salt composition, wherein the molten salt 2 is at least one salt selected from the group consisting of a pyridinium salt, a piperidinium salt, a pyrrolidinium salt, an imidazolium salt, a pyrazolium salt, and an ammonium salt.

Another embodiment of the invention is the molten salt composition, wherein the molten salt 2 is a 1-methyl-1-propylpyrrolidinium salt.

The pyrrolidinium salt refers to a salt of a pyrrolidinium cation or a cation of a pyrrolidinium derivative and an anion represented by (RSO₂)₂N⁻. The derivative refers to one of which hydrogen atom within the molecule, particularly hydrogen atom bound to a nitrogen atom, is substituted with an alkyl group or the like. Thus, examples of the derivative of pyrrolidinium include 1-methyl-1-propylpyrrolidinium (also sometimes referred to as methyl propylpyrrolidinium), and the like. What applies to the pyrrolidinium salt also applies for the pyridinium salt, the piperidinium salt, the imidazolium salt, the pyrazolium salt, and the ammonium salt.

When the molten salt 2 is a salt of a derivative, the derivative is preferably selected such that the ratio of the ion diameter of the cation of the molten salt 2 against the ion diameter of the cation of the molten salt 1 falls within the above described range, and such that the molten salt 2 is liquid at an ordinary temperature.

Each of the pyridinium salt, the piperidinium salt, the pyrrolidinium salt, the imidazolium salt, the pyrazolium salt, and the ammonium salt are ordinarily cations having an ion diameter of about 9 to 15 angstrom, and are suitable as a cation for forming the molten salt 2 when the cation forming the molten salt 1 is Na⁺. Among them, a methyl propylpyrrolidinium salt, which is a salt of a pyrrolidinium derivative, is preferable, since the molten salt composition lacking a clear melting point can be formed by combining the methyl propylpyrrolidinium salt with the molten salt 1 of which cation is Na⁺ such that the composition ratio between the molten salt 1 and the molten salt 2 is within the specific range.

Another embodiment of the invention is the molten salt composition, wherein the anion represented by (RSO₂)₂N⁻ is at least one anion selected from the group consisting of bis(fluorosulfonyl)amide, bis(trifluoroalkylsulfonyl)amides, and fluorosulfonyl(trifluoroalkylsulfonyl)amides.

Examples of the anions forming the molten salt 1 and the molten salt 2 include bis(fluorosulfonyl)amide, bis(trifluoroalkylsulfonyl)amides, fluorosulfonyl(trifluoroalkylsulfonyl)amides, and the like. Examples of a fluoroalkyl represented by “R” include groups obtained by substituting one part of hydrogen atoms or all hydrogen atoms of lower alkyls, such as ethyl, propyl, and butyl, with fluorine. Among those, trifluoromethyl is preferable.

Another embodiment of the invention is the molten salt composition, wherein the molten salt 1 is at least one salt selected from the group consisting of NaFSA, sodium bis(trifluoromethylsulfonyl)amide (represented by NaTFSA), and sodium fluorosulfonyl(trifluoromethylsulfonyl)amide (represented by NaFTA). Na⁺ having an ion diameter of 1.9 angstrom is preferable as the cation forming the molten salt 1, since a molten salt composition lacking a clear melting point can be easily formed in combination with the molten salt 2.

Another embodiment of the invention is the molten salt composition, wherein the molten salt 1 is NaFSA, wherein the molten salt 2 is methyl propylpyrrolidinium bis(fluorosulfonyl)amide (MPPyrFSA), and wherein NaFSA/(NaFSA+MPPyrFSA) (mole ratio) is larger than 0.1.

Another embodiment of the invention is the molten salt composition, wherein the molten salt 1 is NaFSA, wherein the molten salt 2 is MPPyrFSA, and wherein NaFSA/(NaFSA+MPPyrFSA) (mole ratio) is not larger than 0.55.

The molten salt composition lacking a clear melting point is formed by using NaFSA as the molten salt 1, MPPyrFSA as the molten salt 2, at NaFSA/(NaFSA+MPPyrFSA) (mole ratio) in a range larger than 0.1 or in a range not larger than 0.55.

Another embodiment of the invention is the molten salt composition, wherein the molten salt 1 is NaFSA, the molten salt 2 is MPPyrFSA, and NaFSA/(NaFSA+MPPyrFSA) (mole ratio) is 0.2 to 0.5.

By increasing the ratio of NaFSA, discharge characteristic becomes particularly fine. However, when the ratio of NaFSA becomes high, the viscosity of the molten salt composition increases and handling becomes not easy (ease of handling reduces). Thus, as the composition of the molten salt composition, a composition satisfying both the battery characteristic and the ease of handling when manufacturing the battery is desired. The above embodiment of the invention proposes an optimum composition satisfying both the battery characteristic and the ease of handling when manufacturing the battery. Thus, when NaFSA/(NaFSA+MPPyrFSA) (mole ratio) is within a range of not smaller than 0.2 and not larger than 0.5, the molten salt composition lacking a clear melting point can be formed with further certainty, and the battery characteristic and the ease of handling when manufacturing the battery can both be satisfied. Further preferably, NaFSA/(NaFSA+MPPyrFSA) (mole ratio) is not smaller than 0.35 and not larger than 0.45.

Another embodiment of the invention is a secondary battery including as an electrolytic solution, the molten salt composition.

Since the molten salt composition lacks a clear melting point as described above, the secondary battery of one embodiment of the present invention including the molten salt composition as an electrolytic solution can be expected to stably operate while maintaining an available state without rapidly becoming unavailable even when the temperature becomes low.

More specifically, the battery is a storage battery that does not become unavailable because of rapid solidification of the molten salt, even though its output can gradually decrease by lowering the temperature. In addition, since the molten salt having the configuration of the embodiment is used as an electrolytic solution, the advantage of being a molten salt battery that is nonflammable and has high energy density is obtained, and operation at low temperature is possible.

Another embodiment of the invention is the secondary battery, including: a positive electrode of which active material is sodium compound; a negative electrode of which active material is at least one member selected from the group consisting of graphite compounds, sodium titanate, tin, zinc, and silicon alloys; and a porous separator interposed between the positive electrode and the negative electrode.

As like conventionally known molten salt batteries, the secondary battery including the molten salt composition of the present invention as an electrolytic solution can have a configuration including a positive electrode, a negative electrode, and a porous separator interposed between the positive electrode and the negative electrode. As the positive electrode, the negative electrode, and the porous separator; similar ones used in a conventionally known molten salt battery can be used.

As an active material of the positive electrode, a material containing a sodium compound is preferable. That is, a sodium secondary battery is preferable. More preferably, 5 mass % or more of the total amount of the active material is Na. Examples of the sodium compound include sodium oxide, and the like. Examples of the structure of the positive electrode include those having an active material layer formed on the surface of a current collector formed from aluminum or the like.

Examples of the active material of the negative electrode include carbon, silicon, a silicon alloy, tin, zinc, a titanium oxide such as sodium titanate, and metallic sodium, and the like. Examples of the carbon include a graphite compound. Among those described above, a graphite compound, sodium titanate, tin, zinc, and a silicon alloy are preferable. A conduction aid and a binder can also be mixed with the active material of the negative electrode. Examples of the structure of the negative electrode include those having an active material layer formed on the surface of a current collector formed from aluminum, SUS, copper, and the like.

Another embodiment of the invention is assembled battery system including a combination of the secondary battery (secondary battery of the above embodiment of the present invention), and another secondary battery.

Another secondary battery means a secondary battery other than the secondary battery of the present invention. Examples thereof include a lithium ion battery and a molten salt battery including as an electrolytic solution, a molten salt having a clear melting point.

In the assembled battery system, the secondary battery of the present invention can be used as a startup battery at low temperature. The secondary battery of the present invention can be used stably even at low temperature, and can also function as a heater by generating heat through discharging one portion or all the stored power. Thus, the secondary battery of the present invention can also be used as a heater when the assembled battery system is used at low temperature. For example, when the other battery is a molten salt battery including as an electrolytic solution a molten salt having a clear melting point, the secondary battery of the present invention can also be also used as a heater for heating and actuating the other battery when the assembled battery system is used at low temperature.

### Advantageous Effects of Invention

The molten salt composition of the present invention is characterized in that the molten salt composition is in a liquid state at an ordinary temperature and lacks a clear melting point. Thus, the secondary battery of the present invention including the molten salt as an electrolytic solution can operate at an ordinary temperature, has advantages of having high energy density and being nonflammable, and is maintained in an available state without rapidly becoming unavailable even when the temperature is lowered.

### BRIEF DESCRIPTION OF DRAWINGS

FIG. 1 is a graph showing DSC curves of molten salt compositions obtained in Experiment 1.

FIG. 2 is a graph showing charge/discharge curves obtained in Experiment 2.

FIG. 3 is a schematic sectional view showing one example of a structure of a secondary battery of the present invention.

FIG. 4 is a graph showing a charge/discharge curve obtained in Experiment 3.

FIG. 5 is a graph showing the result of viscosity measurement assay obtained in Experiment 6.

### DESCRIPTION OF EMBODIMENTS

In the following, the present invention will be described based on embodiments and Examples. The present invention is not limited to the following embodiments and Examples, and various modifications can be made within the scope identical or equivalent to that of the present invention.

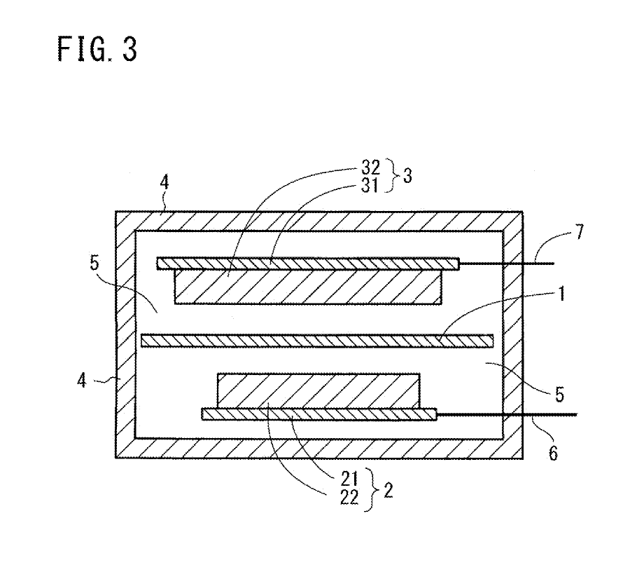

FIG. 3 is a schematic sectional view showing one example of the structure of the secondary battery of the present invention. In the figure, “1” represents a porous separator, “2” being a positive electrode, “3” being a negative electrode, “4” being a battery container, “5” being a molten salt composition, and “6” and “7” each being a lead wire. The positive electrode 2 includes a sheet-like current collector 21 and a positive electrode material 22. The current collector 21 is formed by an aluminum alloy or the like.

A sodium compound is used as a positive electrode active material forming the positive electrode material 22. In the example in FIG. 3, the positive electrode material 22 is a mixture obtained by mixing a binder, a conduction aid, and a positive electrode active material including an oxide of sodium. A layer of the positive electrode material 22 is formed by applying this mixture on the current collector 21.

As the sodium compound which is the positive electrode active material, a compound represented by the formula NaxM1yM2zM3w can be used. In the formula, M1 represents any one of Fe, Ti, Cr, V, or Mn, M2 being either PO₄ or S, and M3 being either F or O. Additionally, in the formula, the composition ratio x of Na is a real number satisfying the relationship of 0≦x≦2, the composition ratio y of M1 being a real number satisfying the relationship of 0≦y≦1, the composition ratio z of M2 being a real number satisfying the relationship of 0≦z≦2, the composition ratio w of M3 being a real number satisfying the relationship of 0≦w≦3, wherein the relationship of x+y>0 is satisfied, and the relationship of z+w>0 is satisfied.

Examples of the metallic compound represented by the above described formula include NaCrO₂, NaTiS₂, NaMnF₃, Na₂FePO₄F, NaVPO₄F, NaMnO₂, and the like. At least one member selected from the compounds exemplified above is preferably used as the positive electrode active material. Among them, it is preferred that NaCrO₂ is used.

The negative electrode 3 includes a sheet-like current collector 31 and a negative electrode material 32. The current collector 31 is formed from an aluminum alloy, SUS, or the like. Examples of the negative electrode active material forming the negative electrode material 32 include a titanium oxide, silicon, a silicon alloy, tin, zinc, carbon such as a graphite compound, and metallic sodium. In the example shown in FIG. 3, the negative electrode material 32 is formed by mixing a binder, a conduction aid, and a powder of the negative electrode active material. A layer of the negative electrode material 32 is formed by applying this mixture on the current collector 31.

A porous separator 1, which is to be arranged between positive and negative electrodes, is formed in a sheet-like manner, and is interposed between the positive electrode 2 and the negative electrode 3 so as to separate the positive electrode 2 from the negative electrode 3. In addition, the interval between the positive electrode 2 and the negative electrode 3 is filled with the molten salt composition 5 (electrolytic solution) of the present invention. Thus, the porous separator 1 is immersed in the molten salt composition 5. When the battery is in operation, sodium ions pass through the porous separator 1 and move within the molten salt composition 5. Thus, the porous separator 1 has pores through which ions can move.

Examples of the material forming the porous separator 1 include polyolefin, polyaramide, glass, and polypropylene sulfide. In addition, the shape of the porous separator is not limited to the sheet-like form, as long as the form can be immersed in the molten salt and can separate the positive electrode and the negative electrode. For example, a bag-like shape that wraps the positive electrode or the negative electrode can be used.

The porous separator 1, the positive electrode 2, the negative electrode 3, and the molten salt composition 5 are encapsulated within the battery container 4. The lead wires 6 and 7 are respectively connected to the positive electrode 2 and the negative electrode 3. Current is output from the battery through these lead wires. The battery container 4 can be formed from a material having insulation property such as resin. In the example in FIG. 3, although the battery container 4 is formed in a box shape, the battery container 4 can be formed in a bag-like shape with a flexible material. The shape can also be that of a coin cell. Although materials having conductive property such as aluminum and other metal can be used as the material forming the battery container 4, in such cases, in order to prevent short circuiting among the positive electrode 2, the negative electrode 3, and the lead wires 6 and 7, those surfaces and parts in contact with the lead wires are coated with a material having insulation property such as a resin.

The battery can further include means conventionally known in the art used in a conventional molten salt battery, such as means for absorbing volume change of the positive electrode 2 and the negative electrode 3.

### Examples

### Experiment 1

### DSC Measurement

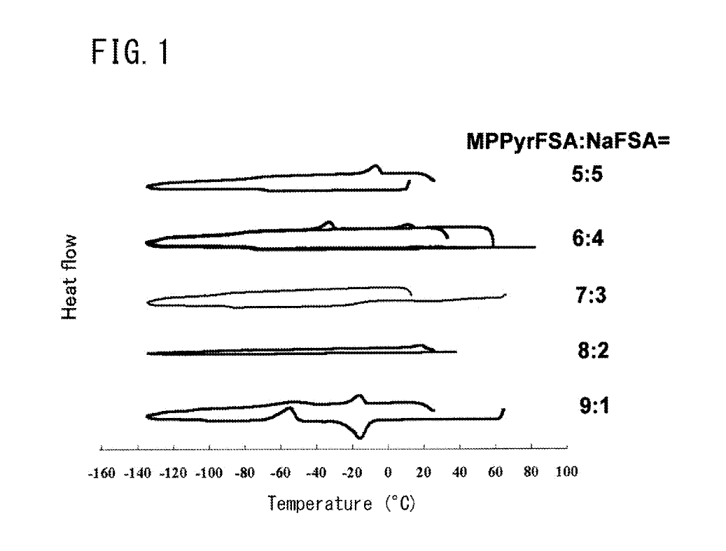

Five kinds of molten salt compositions were produced by mixing sodium bis(fluorosulfonyl)amide (NaFSA, manufactured by Mitsubishi Materials Corp.) and methyl propylpyrrolidinium bis(fluorosulfonyl)amide (MPPyrFSA, manufactured by BioTrek) at a mole ratio of 1:9, 2:8, 3:7, 4:6, and 5:5. DSC measurement was performed on these molten salt compositions using Shimadzu DSC-60 (manufactured by Shimadzu Corp.) at a scan rate of 10° C./minute. The resulting DSC curves are shown in FIG. 1. Measurement of glass transition points of the resulting molten salt compositions was also performed. The result is shown in the following table.

TABLE 1

| MPPyrFSA:NaFSA | Tg (° C.) |
|---|---|
| 5:05 | −65.9 |
| 6:04 | −71.5 |
| 7:03 | −85.9 |
| 8:02 | −90.8 |
| 9:01 | −100.8 |

As it is clear from FIG. 1, a clear endothermic peak, i.e., a melting point, was observed at around −17° C. (−25° C. to −10° C.) in the DSC curve of the molten salt composition of MPPyrFSA:NaFSA=9:1. On the other hand, an endothermic peak was not observed in the DSC curves of the molten salt compositions of MPPyrFSA:NaFSA=8:2, 7:3, 6:4, and 5:5. Thus, it is obvious from this result that the molten salt composition including NaFSA of which cation is Na⁺ having an ion diameter of 1.9 angstrom and MPPyrFSA of which cation is methyl propylpyrrolidinium having an ion diameter of approximately 10 angstrom (the ratio of ion diameter thereof against Na⁺ is approximately 5 times) becomes a molten salt composition lacking a clear melting point at a range of MPPyrFSA:NaFSA=8:2 to 5:5.

As described above, a clear melting point was observed at around −17° C. with the molten salt composition of MPPyrFSA:NaFSA=9:1. On the other hand, a measurement result is also obtained indicating that when NaFSA/(NaFSA+MPPyrFSA) (mole ratio) is larger than 0.56, the composition becomes solid at room temperature (25° C.). From these results, it is shown that, in the molten salt composition including MPPyrFSA and NaFSA, the range of NaFSA/(NaFSA+MPPyrFSA) (mole ratio) for obtaining a molten salt composition which does not have a clear melting point and does not solidify at room temperature is larger than 0.1 but not larger than 0.55.

### Experiment 2

A positive electrode and a negative electrode were arranged in a coin cell (2032 type coin cell) of which the exterior part material is stainless steel and of which inner surface has an insulating film of polytetrafluoroethylene (PTFE) provided thereon. A polyolefin porous separator (NPS 50 μm) was disposed between the positive electrode and the negative electrode. Then, interval among the positive electrode, the negative electrode, and the separator was filled with the molten salt composition (example of the present invention) in which MPPyrFSA:NaFSA was 8:2, to give a secondary battery. The configuration of the positive electrode and negative electrode is shown below.

Positive electrode: An aluminum-foil applied product obtained by applying, on an aluminum foil, a positive electrode material obtained by mixing NaCrO₂, Denka Black (carbon black manufactured by Denki Kagaku Kogyo K. K.), and polyvinylidene fluoride at a mass ratio of 85:10:5.
Negative electrode material: A mixture of hard carbon and a polyimide binder at a mass ratio of 92:8.

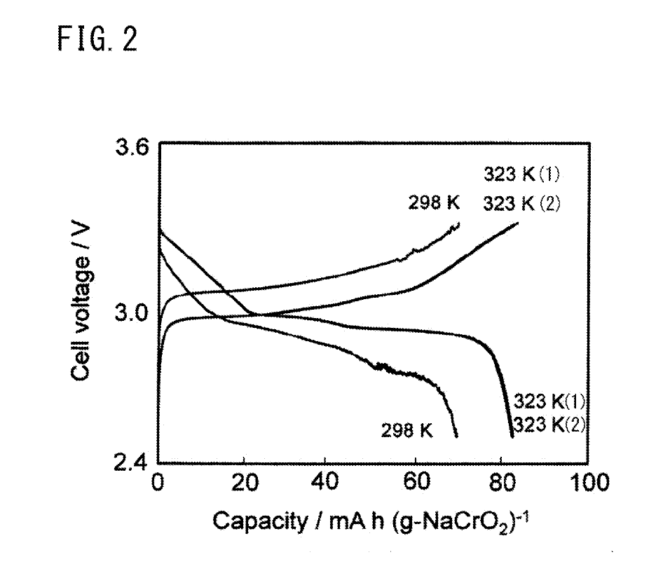

A charge/discharge test was performed on the produced secondary battery by repeating charge/discharge at a voltage range of 2.5 to 3.5 V, current value of 0.1 C equivalent, and a temperature of 25° C. (298 K) or 50° C. (323 K). The resulting charge/discharge curves (Cell Voltage vs Capacity) are shown in FIG. 2. FIG. 2 shows that the secondary battery including as an electrolytic solution the molten salt composition in which MPPyrFSA:NaFSA is 8:2, operates with high energy density in a range from 25° C. (298 K) to 50° C. (323 K). Each of 298 K and 323 K in the figure shows the temperature (absolute temperature) at which the charge/discharge was performed, and that (1) and (2) for 323 K respectively represent the first charge/discharge and the second charge/discharge when the charge and discharge was repeated.

### Experiment 3

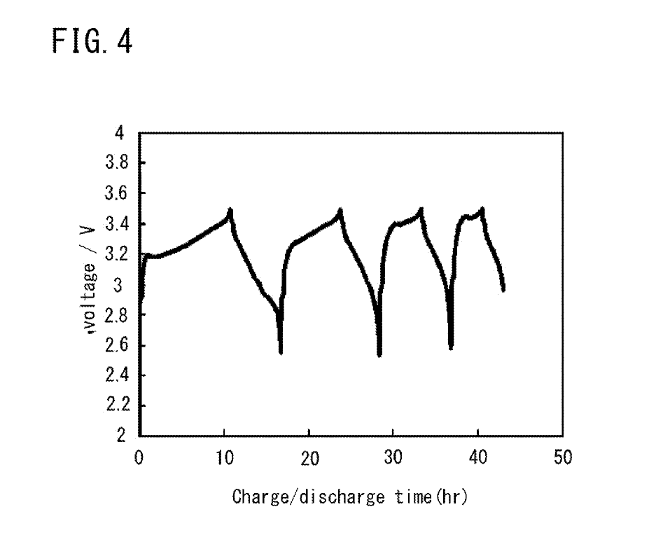

A charge/discharge test was performed by repeating charge/discharge in the same manner as in Experiment 2, using the same aluminum-foil applied product used in Experiment 2 as the positive electrode, metallic sodium as the negative electrode material, a polyolefin porous separator (NPS 50 m) as the separator, a voltage range of 2.5 to 3.5 V, current value of 0.05 C equivalent, and a temperature of −10° C. The resulting charge/discharge curve (change in cell voltage with respect to charge/discharge time) is shown in FIG. 4. As shown in FIG. 4, this secondary battery operates at high energy density even at −10° C. (263 K).

### Experiment 4

In a manner similar to Experiment 1, each of five kinds of molten salt compositions was produced by mixing NaFSA (manufactured by Mitsubishi Materials Corp.) and MPPyrFSA (manufactured by BioTrek) at a mole ratio of 1:9, 2:8, 3:7, 4:6, and 5:5.

In a manner similar to Experiment 2, a positive electrode (same as Experiment 2 using an aluminum-foil applied product obtained by applying, on an aluminum foil, a positive electrode material obtained by mixing NaCrO₂, Denka Black, and polyvinylidene fluoride at a mass ratio of 85:10:5) and a negative electrode (metallic sodium) were arranged in a coin cell (2032 type coin cell). A polyolefin porous separator (NPS 50 μm) was disposed between the positive electrode and the negative electrode. Then, interval among the positive electrode, the negative electrode, and the separator was filled with the one of the above produced five kinds of molten salt compositions to give secondary batteries.

A charge/discharge test was performed on each of the resulting five kinds of secondary batteries at a temperature of 90° C. (363 K), a current value of 0.1 C-rate, and a voltage range of 1.5 to 3.5 V. As a result, the initial discharge capacities (mAh/g (NaCrO₂)) at 0.1 C of all the batteries showed almost the same value.

Next, the discharge rate characteristic (discharge capacity ratio) of the five kinds of batteries having these different compositions of molten salt was evaluated by changing the discharge rate to 0.5 C, 1 C, 2 C and 5 C while keeping the charge rate to 0.1 C at 90° C. The result is shown in the following table.

TABLE 2

| Composition of molten salt | Discharge capacity ratio (%) | | | | |
|---|---|---|---|---|---|
| (molar ratio) | at each discharge rate | | | | |
| NAFSA:MPPyrFSA | 0.1 C | 0.5 C | 1 C | 2 C | 5 C |
| 50:50 | 100 | 98.7 | 97.1 | 92.5 | 64.5 |
| 40:60 | 100 | 98.6 | 96.2 | 92.3 | 60.2 |
| 30:70 | 100 | 98.5 | 96.0 | 92.1 | 47.1 |
| 20:80 | 100 | 96.2 | 92.3 | 80.4 | 32.1 |
| 10:90 | 100 | 93.7 | 71.6 | 47 | 11.7 |

Discharge capacity ratio in the table is shown as ratio of discharge capacity when the discharge ratio at 0.1 C is taken as 100%.

From the result in Table 2, it was confirmed that the discharge characteristic (discharge capacity ratio) is improved when the NaFSA ratio (sodium concentration) in the composition of molten salt increases. In particular, the improvement in discharge characteristic due to the increase in NaFSA ratio is significant when the discharge rate is 2 C and 5 C. At a discharge rate not larger than 2 C, the discharge capacity ratio exceeds 80% when NaFSA/(NaFSA+MPPyrFSA) (mole ratio) is 0.2 or higher. This result shows that NaFSA/(NaFSA+MPPyrFSA) (mole ratio) is preferably 0.2 or higher in order to achieve excellent discharge characteristic.

### Experiment 5

Five kinds of secondary batteries were produced in the same manner as in Experiment 4, except for using in place of metallic sodium, as a negative electrode, a product obtained by applying, on an aluminum foil, a mixture of a polyimide binder and a hard carbon which is the active material at a mass ratio of 92:8. A charge/discharge test was performed on each of the resulting five kinds of secondary batteries at a temperature of 90° C. (363 K), a current value of 0.2 C-rate, and a voltage range of 1.5 to 3.5 V. The evaluation was performed assuming that the capacity ratio between the positive-electrode capacity and the negative-electrode capacity was almost constant for all the batteries. As a result of the charge/discharge test at 0.2 C-rate, the initial discharge capacities of all batteries at 0.2 C were confirmed to be almost constant.

Next, the discharge rate characteristic of the five kinds of batteries having these different compositions of molten salt was evaluated by changing the discharge rate to 0.5 C, 1 C, 2 C and 5 C while keeping the charge rate to 0.2 C at 90° C. The result is shown in the following table.

TABLE 3

| Composition of molten salt | Discharge capacity ratio (%) | | | | |
|---|---|---|---|---|---|
| (molar ratio) | at each discharge rate | | | | |
| NAFSA:MPPyrFSA | 0.2 C | 1 C | 2 C | 4 C | 6 C |
| 50:50 | 100 | 97.9 | 96.5 | 98.6 | 73.7 |
| 40:60 | 100 | 97.8 | 95.7 | 90.4 | 67.5 |
| 30:70 | 100 | 97.8 | 95.2 | 69.8 | 30.1 |
| 20:80 | 100 | 98.4 | 92.2 | 40.8 | — |
| 10:90 | 100 | 85.0 | 33.8 | — | — |

Discharge capacity ratio in the table is shown as ratio of discharge capacity when the discharge ratio at 0.2 C is taken as 100%.

From the result in Table 3, it was also confirmed that the discharge characteristic (discharge capacity ratio) is improved when the NaFSA ratio (sodium concentration) in the composition of molten salt increases. At a discharge rate not larger than 2 C, the discharge capacity ratio exceeds 90% at NaFSA/(NaFSA+MPPyrFSA) (mole ratio) of 0.2 or higher. This result also shows that NaFSA/(NaFSA+MPPyrFSA) (mole ratio) is preferably 0.2 or higher in order to achieve excellent discharge characteristic.

### Experiment 6

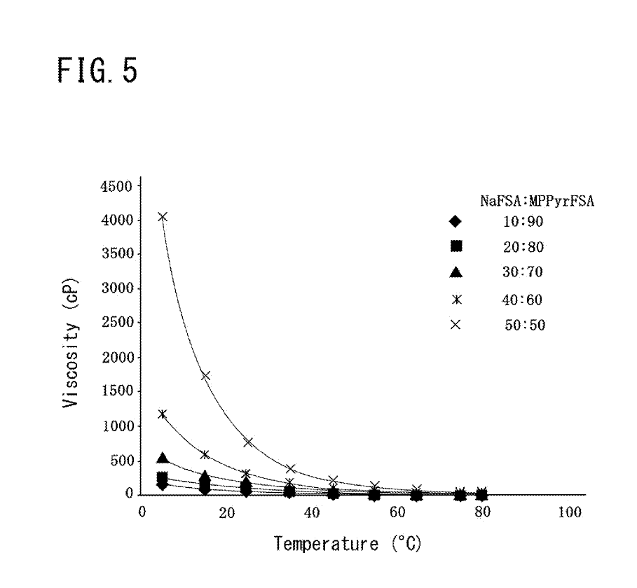

Next, viscosity was measured at various temperatures using the five kinds of molten salt compositions used in Experiment 4 and Experiment 5. For this measurement, a rotational viscometer type DV-II+Pro manufactured by Brookfield Engineering Laboratories was used. The measurement result is shown in FIG. 5.

As it is clear from FIG. 5, the viscosity rapidly increases with an increase in NaFSA ratio (sodium concentration) in the molten salt composition and the lowering of temperature. When the viscosity exceeds 500 cP, workability of pouring operation, and the like of the molten salt material when assembling the battery deteriorates gradually. In addition, when the viscosity becomes high, it becomes difficult to distribute electrolytes uniformly within the battery.

FIG. 5 shows that, when NaFSA:MPPyrFSA is 40:60 or 50:50, although the viscosity is 500 cP or higher at a temperature of about 20° C., workability does not largely deteriorate if work is done at a temperature somewhat higher than room temperature. On the other hand, it is conceivable that workability will further deteriorate to cause problems when the ratio of NaFSA becomes even larger and NaFSA/(NaFSA+MPPyrFSA) (mole ratio) is larger than 0.5.

From the results of Experiments 4 to 6, it is shown that NaFSA/(NaFSA+MPPyrFSA) (mole ratio) is preferably 0.2 to 0.5 in order to satisfy improvement of discharge characteristic, improvement of workability during battery assembly, and uniform distribution of electrolytes within the battery. NaFSA/(NaFSA+MPPyrFSA) (mole ratio) is more preferably 0.35 to 0.45.

1. A molten salt composition comprising a mixture of two or more kinds of molten salts usable as an electrolytic solution of a secondary battery, the molten salt composition lacking a clear melting point.

2. The molten salt composition according to claim 1, wherein at least one kind of the molten salts among the two or more kinds of the molten salts is a molten salt 2 having a melting point not higher than 25° C.

3. The molten salt composition according to claim 2, wherein at least one kind of the molten salts among the two or more kinds of the molten salts is a molten salt 1 including an alkaline metal cation and an anion represented by (RSO₂)₂N⁻
wherein two “R”s each independently represent a fluorine atom or a fluoroalkyl group.

4. The molten salt composition according to claim 3,
wherein an anion forming the molten salt 2 is an anion represented by (RSO₂)₂N wherein two “R”s each independently represent a fluorine atom or a fluoroalkyl group;
wherein an ion diameter of a cation forming the molten salt 2 is not smaller than 3 times of an ion diameter of the alkaline metal cation forming the molten salt 1; and
wherein a composition ratio of the molten salt 1 and the molten salt 2 is a composition ratio within a range in which the molten salt composition lacks a clear melting point.

5. The molten salt composition according to claim 3, wherein the molten salt 2 is at least one salt selected from the group consisting of pyridinium salts, piperidinium salts, pyrrolidinium salts, imidazolium salts, pyrazolium salts, and ammonium salts.

6. The molten salt composition according to claim 5, wherein the molten salt 2 is a 1-methyl-1-propylpyrrolidinium salt.

7. The molten salt composition according to claim 3, wherein the anion represented by (RSO₂)₂N⁻ is at least one anion selected from the group consisting of bis(fluorosulfonyl)amide, bis(trifluoroalkylsulfonyl)amides, and fluorosulfonyl(trifluoroalkylsulfonyl)amides.

8. The molten salt composition according to claim 3, wherein the molten salt 1 is at least one salt selected from the group consisting of sodium bis(fluorosulfonyl)amide, sodium bis(trifluoromethylsulfonyl)amide, and sodium fluorosulfonyl(trifluoromethylsulfonyl)amide.

9. The molten salt composition according to claim 3,
wherein the molten salt 1 is sodium bis(fluorosulfonyl)amide;
wherein the molten salt 2 is methyl propylpyrrolidinium bis(fluorosulfonyl)amide; and
wherein sodium bis(fluorosulfonyl)amide/(sodium bis(fluorosulfonyl)amide+methyl propylpyrrolidinium bis(fluorosulfonyl)amide) (mole ratio) is larger than 0.1.

10. The molten salt composition according to claim 3,
wherein the molten salt 1 is sodium bis(fluorosulfonyl)amide;
wherein the molten salt 2 is methyl propylpyrrolidinium bis(fluorosulfonyl)amide; and
wherein sodium bis(fluorosulfonyl)amide/(sodium bis(fluorosulfonyl)amide+methyl propylpyrrolidinium bis(fluorosulfonyl)amide) (mole ratio) is not larger than 0.55.

11. The molten salt composition according to claim 3,
wherein the molten salt 1 is sodium bis(fluorosulfonyl)amide;
wherein the molten salt 2 is methyl propylpyrrolidinium bis(fluorosulfonyl)amide; and
wherein sodium bis(fluorosulfonyl)amide/(sodium bis(fluorosulfonyl)amide+methyl propylpyrrolidinium bis(fluorosulfonyl)amide) (mole ratio) is 0.2 to 0.5.

12. A secondary battery comprising as an electrolytic solution, the molten salt composition according to claim 1.

13. The secondary battery according to claim 12, comprising:
a positive electrode of which active material is a sodium compound;
a negative electrode of which active material is at least one member selected from the group consisting of graphite compounds, sodium titanate, tin, zinc, and silicon alloys; and
a porous separator interposed between the positive electrode and the negative electrode.

14. An assembled battery system comprising a combination of the secondary battery according to claim 12, and another secondary battery.
